(19) United States
(12) Patent Application Publication
(10) Pub. No.: US 2008/0008416 A1
(43) Pub. Date: Jan. 10, 2008

(54) Opto-electronic device

(75) Inventors: Kelvin Prosyk, Ottawa (CA); Guy Robert Towlson, Towcester (GB)

Correspondence Address: LAHIVE & COCKFIELD, LLP, ONE POST OFFICE SQUARE, BOSTON, MA, 02109-2127, US

(73) Assignee: BOOKHAM TECHNOLOGY, PLC, Towcester (GB)

(21) Appl. No.: 11/267,400

(22) Filed: Nov. 3, 2005

Related U.S. Application Data
(63) Continuation-in-part of application No. 11/237,067, filed on Sep. 27, 2005, now abandoned.
Application No. 11/237,067 is a continuation-in-part of application No. 10/073,101, filed on Feb. 12, 2002, now Pat. No. 6,973,232.

(51) Int. Cl. G02B 6/26

(52) U.S. Cl. 385/20

(57) ABSTRACT

An opto-electronic device comprises a waveguide along which light may propagate and an electrode associated with the waveguide and arranged to apply a variable electric field thereto. The waveguide includes one or more active regions in which variations in the electric field applied by the electrode to the waveguide cause variations in absorption of the light, and one or more passive regions in which variations in the electric field applied by the electrode to the waveguide cause substantially no variations in any absorption of the light. Relative proportions of the waveguide that comprise the active and passive regions vary along at least part of the length of the waveguide.

### RELATED APPLICATION

This Application is a Continuation-in-part of U.S. patent application Ser. No. 11/237067 filed Sep. 27, 2005, which is a Continuation-in-part of U.S. patent application Ser. No. 10/073101 filed on Feb. 12, 2002.

### BACKGROUND OF THE INVENTION

The present invention relates to opto-electronic devices, especially integrated opto-electronic devices, for example formed from semiconductor materials.

Integrated opto-electronic devices commonly include optical attenuators and modulators that control the intensity of the propagated light. The accompanying FIG. 1 illustrates, schematically, a known optical modulator, which functions by the well-known mechanism of electro-absorption. The modulator 1 comprises a semiconductor rib single-mode waveguide 3 formed in a semiconductor substrate 5 by well-known etching techniques. In use, light (i.e. an optical mode) propagates along the waveguide in the direction indicated by the arrow. A first electrode 7 of the modulator is formed from a layer of metal deposited over the entire width of the rib waveguide 3 along part of its length. A further electrode 8 (e.g. a ground electrode) of the modulator is formed on the substrate. In use, the light propagating along the waveguide 3 is modulated by an electric field applied to the waveguide via the electrodes 7 and 8. (n and p doped regions of the device are situated on opposite sides of the waveguide 3 adjacent to respective electrodes.)

A typical profile of the absorption of the light per unit length along the waveguide (i.e. the “absorption density” along the waveguide) is in the form of a decay curve, with a large peak at the input of the modulator. This is shown in FIG. 2, which is a graph of absorbed optical power density (in mW/μm) versus position (in μm) along the “cavity”, or waveguide, from the input of the modulator (i.e. from the front edge of the first electrode). Light absorption causes heat generation, and in some prior art devices the limiting design parameter has commonly been the amount of heat that can be locally dissipated out of the waveguide (principally into the substrate) at the input region of the device. Excess heat generation in the known devices can cause failure due to catastrophic optical damage (“COD”) or at least reduced reliability (and thus reduced device lifetime) due to raised temperatures (causing enhanced deleterious diffusion of atoms within the structure, for example). In addition to COD, in known optical modulator devices light absorption due to direct bandgap transitions commonly causes charge carriers (electrons and holes) to be generated. Even if heat is adequately managed, an accumulation of carriers (particularly holes) at high optical powers can cause undesirable effects, such as pattern dependent jitter.

Consequently, in order to maintain the optical absorption density in the input region of such known devices beneath the level at which damage or excessive carrier accumulation occurs, it is generally necessary to restrict the electrical voltage applied to the device and to make the device longer to compensate. (A typical length of such a device can be 100 to 500 μm.)

Thus, there is a need in the art for an improved device that overcomes the above problems, and which can (for example) be shorter, more reliable, and/or can be driven with a higher drive voltage than the prior art devices. The present invention seeks (among other things) to provide such a device.

### SUMMARY OF THE INVENTION

Accordingly, the present invention provides an opto-electronic device comprising a waveguide along which light may propagate and an electrode associated with the waveguide and arranged to apply a variable electric field thereto, the waveguide including one or more active regions in which variations in the electric field applied by the electrode to the waveguide cause variations in absorption of the light, and one or more passive regions in which variations in the electric field applied by the electrode to the waveguide cause substantially no variations in any absorption of the light, wherein relative proportions of the waveguide that comprise the active and passive regions vary along at least part of the length of the waveguide.

The invention has the advantage that by means of the variation in the relative proportions of the waveguide that comprise the active and passive regions, the optical absorption profile along the waveguide can be altered in a predetermined, controlled, way from the standard decay profile of known devices, for example as shown in FIG. 2. In particular, the invention enables the peak of the absorption profile in the input region of the device to be reduced in height (e.g. flattened), thereby enabling the above-mentioned problems associated with the known devices to be solved or ameliorated.

Preferably, an overlap between the active region(s) and the light propagating along the waveguide varies along at least part of the length of the waveguide. Most preferably, the overlap between the active region(s) and the light propagating along the waveguide increases along the waveguide in the direction of the propagation of the light. This overlap may be quantified as an “overlap factor”, described below.

It is to be understood that it is possible (at least in some embodiments of the invention) for the, or each, passive region of the waveguide to cause absorption of the light. However, variations in the electric field applied by the electrode cause substantially no variations in the absorption of light by the passive regions.

The, or each, passive region of the waveguide may, for example, be electrically insulating or semi-insulating. Consequently, the bulk electrical conductivity of the waveguide along at least part of the length thereof preferably increases in the direction of the propagation of the light.

In preferred embodiments of the invention, the combined cross-sectional area of the passive region(s) in a direction perpendicular to the direction of the propagation of light along the waveguide preferably decreases in the direction of the propagation of the light, along at least part of the length of the waveguide.

At least one passive region of the waveguide may comprise a lateral side region of the waveguide, for example. Advantageously, one or more passive regions (e.g. two or more passive regions) may comprise lateral side regions of the waveguide, e.g. on opposite sides of the waveguide.

In some embodiments of the invention, at least one passive region has the form of stripes or teeth of material in the waveguide. For example, at least some of the stripes or teeth may be oriented such that their longest dimension extends lengthwise along the waveguide. Additionally or alternatively, at least some of the stripes or teeth may be oriented such that their longest dimension extends at least partially across the width of the waveguide.

Preferably at least one passive region of the waveguide comprises an implanted region. The implantation preferably comprises ion implantation. The implanted ions may, for example, be hydrogen ions and/or helium ions.

In some preferred embodiments of the invention, the opto-electronic device comprises an optical modulator. Consequently, in such embodiments, the electric field preferably is applied by a modulating electric voltage supplied to the electrode. The modulating electric voltage preferably is a radio frequency (RF) modulating voltage.

In some alternative embodiments of the invention, the opto-electronic device comprises an optical attenuator. Consequently, in such embodiments, the electric field preferably is applied by a substantially DC voltage supplied to the electrode.

In all embodiments of the invention, the waveguide preferably is a semiconductor waveguide. Preferred semiconductor materials include III-V semiconductors (i.e. semiconductors formed from elements belonging to groups III and V of the periodic table of the elements), but other semiconductor materials may be used. Particularly preferred semiconductors include indium phosphide (Inp) and/or gallium arsenide (GaAs) based systems, for example comprising indium gallium arsenide phosphide (InGaAsP) and/or indium aluminium gallium arsenide (InAlGaAs).

In the broadest aspects of the invention, the waveguide may be substantially any type of waveguide. Preferably, however, the waveguide is a rib waveguide comprising an elongate rib extending along, and proud of, a substrate in which the waveguide is formed, or is a buried ridge waveguide. The waveguide may be either a “strongly” guiding waveguide, or a “weakly” guiding waveguide.

The electrode (which may be referred to as a “first electrode”) preferably is situated on or near a surface of the waveguide. More preferably (e.g. especially if the waveguide is a rib waveguide), the surface of the waveguide is a top surface remote from a substrate in which the waveguide is formed.

Preferably, the opto-electronic device includes a second electrode, preferably situated on or near an opposite surface of the waveguide to that of the first electrode. Preferably the second electrode is grounded (earthed). Preferably the first electrode is negatively biased to apply the electric field across the waveguide.

The optical device preferably includes doped regions; for example, the device may comprise a p-n doped structure, especially a p-i-n doped structure. Most preferably, the optical device comprises an n-doped (or alternatively p-doped) substrate and a p-doped (or alternatively n-doped) cladding layer. An unintentionally doped region preferably is provided between the doped regions, preferably as the (or each) active region and may include quantum wells or quantum dots. Preferably one of the doped layers is electrically biased by the first electrode, and the other doped layer preferably is grounded (earthed) by the second electrode. For example, a p-doped cladding layer may be negatively biased by the first electrode, and an n-doped substrate may be grounded by the second electrode, to produce a reverse biased electric field across the waveguide.

Other preferred and optional features of the invention are described and explained below, and in the dependent claims.

### BRIEF DESCRIPTION OF THE DRAWINGS

Some preferred embodiments of the invention will now be described, by way of example, with reference to the accompanying figures, of which:

FIG. 1 shows, schematically, a known optical modulator;

FIG. 2 shows a graphical representation of a typical optical absorption profile of a known optical modulator;

FIG. 3 shows, schematically, a first embodiment of the invention;

FIG. 4 shows, schematically, a second embodiment of the invention;

FIG. 5 (views (a) and (b)) shows, schematically, cross-sections through the first embodiment of the invention according to FIG. 3;

FIG. 6 (views (a and (b)) shows, schematically, third and fourth embodiments of the invention;

FIG. 7 (views (a and (b)) shows, schematically, fifth and sixth embodiments of the invention;

FIG. 8 shows a graphical comparison between the typical optical absorption profile of a known optical modulator as shown in FIG. 2, and an optical absorption profile of an optical modulator according to the invention; and

FIG. 9 shows an exemplary graphical representation of the normalised “overlap factor” of an optical modulator according to the invention.

### DETAILED DESCRIPTION

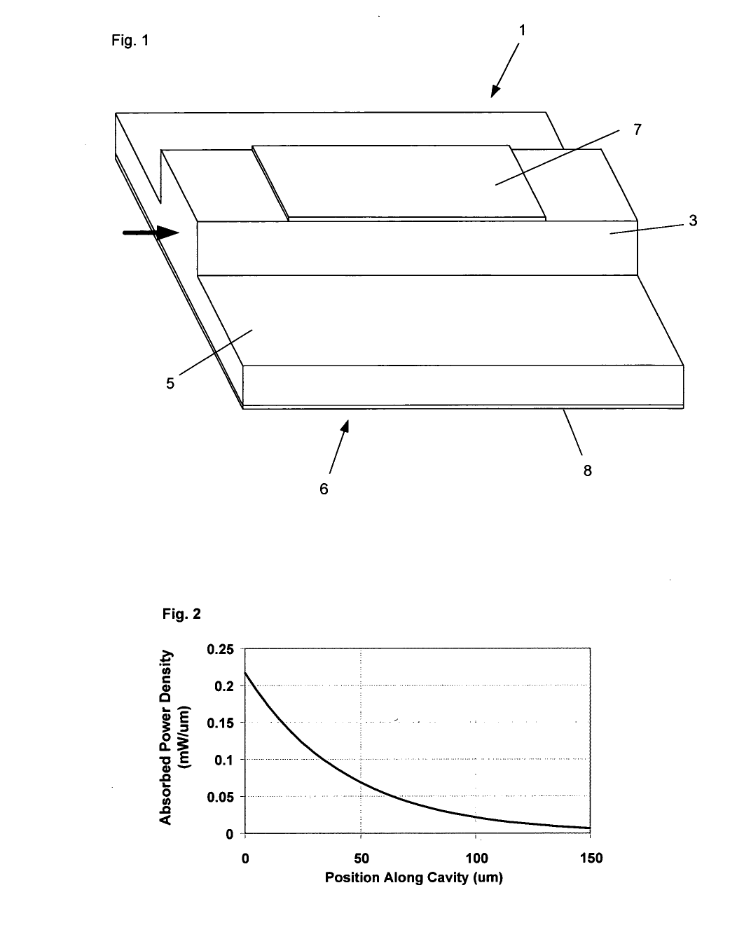

FIGS. 1 and 2 have been described above. FIG. 1 illustrates, schematically, a known optical modulator; FIG. 2 is a graph of absorbed optical power density in mW/μm versus position along the waveguide, in μm in such a known optical modulator.

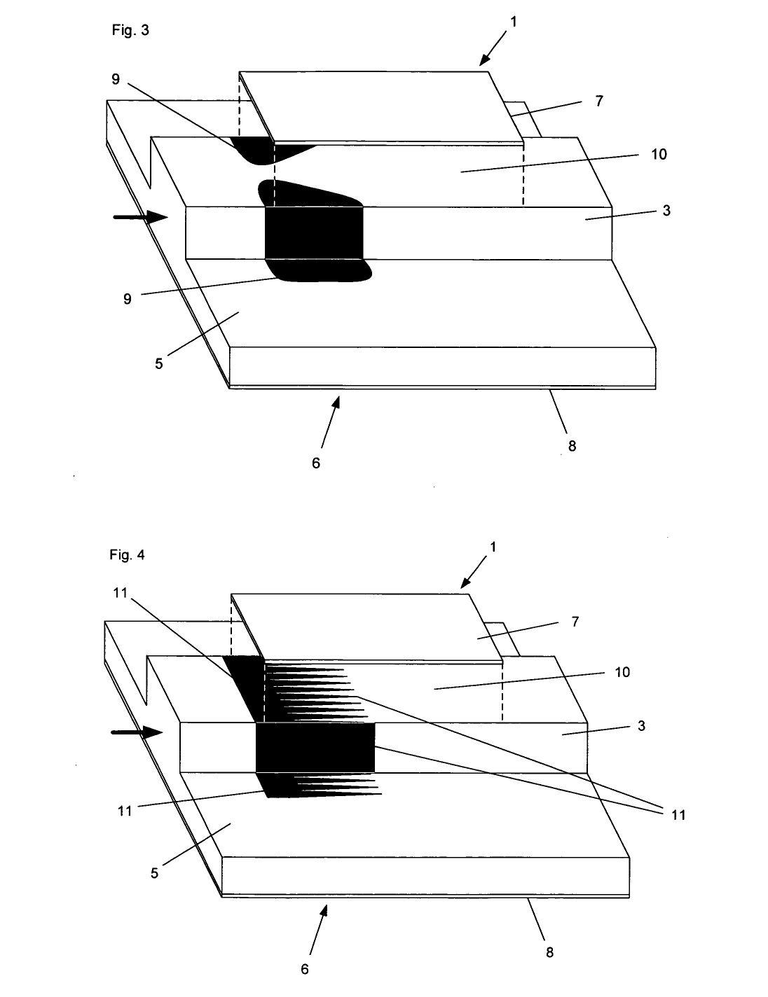

FIGS. 3 to 7 show, schematically, six different preferred embodiments of optical modulator 1 according to the invention. In each case, the modulator 1 comprises a semiconductor waveguide 3 (preferably, as illustrated, a rib waveguide) on a semiconductor substrate 5, a first electrode 7 on the waveguide, and a second electrode 8 on the substrate. The embodiment shown in FIG. 3 is substantially identical to the modulator shown in FIG. 1 and described above, except that the waveguide 3 of the FIG. 3 embodiment of the invention includes regions 9 of implanted ions, for example hydrogen ions and/or helium ions, which cause the waveguide in those regions to be substantially electrically insulating. The regions 9 are passive regions of the waveguide 3; the region 10 of the waveguide below the electrode 7 that does not comprise the passive regions 9, is an active region of the waveguide.

In the FIG. 3 embodiment, the implanted passive regions 9 are located in a front region of the modulator, below a front region of the electrode 7, in the direction of propagation of the light (as indicated by the arrow). The forwardmost edges of the passive regions 9 are situated approximately adjacent to, or slightly forward of, the front region of the electrode 7, and the rearwardmost edges of the passive regions 9 are situated part of the way along the length of the electrode, from the front of the electrode. The passive regions 9 each comprise laterally implanted regions (i.e. implanted into the sides of the rib of the waveguide 3) having a lateral depth that decreases in a direction along the length of the waveguide, from a maximum implantation depth generally at their forwardmost edges to a minimum implantation depth at their rearwardmost edges. As illustrated, the decrease in the lateral depth of each implanted passive region 9 along the waveguide is substantially linear, but other depth profiles are possible, depending upon the particular requirements. In practice, the precise shape, extent and position of each implanted region 9 may be determined by the skilled person by trial and error, or by modelling.

The effect of the implanted passive regions 9 of the modulator according to the invention shown in FIG. 3 is that the peak optical power absorption in the front region of the modulator (i.e. the front region of the electrode 7) is reduced compared to the known modulator shown in FIG. 1, because the width of the active region 10 of the waveguide in this front region that absorbs light by electro-absorption, is reduced. Where the waveguide does not contain implanted ions that reduce its electrical conductivity (i.e. the active region 10), the optical power absorption density is similar to that in the known device, but because there are regions (the passive regions 9) where there is little or no optical power absorption, the average, or overall, effect, is that the absorbed optical power density is reduced. The more important effect, however, is the reduction in the optical power absorption density in the front region of the device. Furthermore, because the passive regions 9 containing implanted ions diminish in width along their length, the width of waveguide where optical power absorption occurs increases, and thus the overlap factor increases along the length of the waveguide between the passive regions 9.

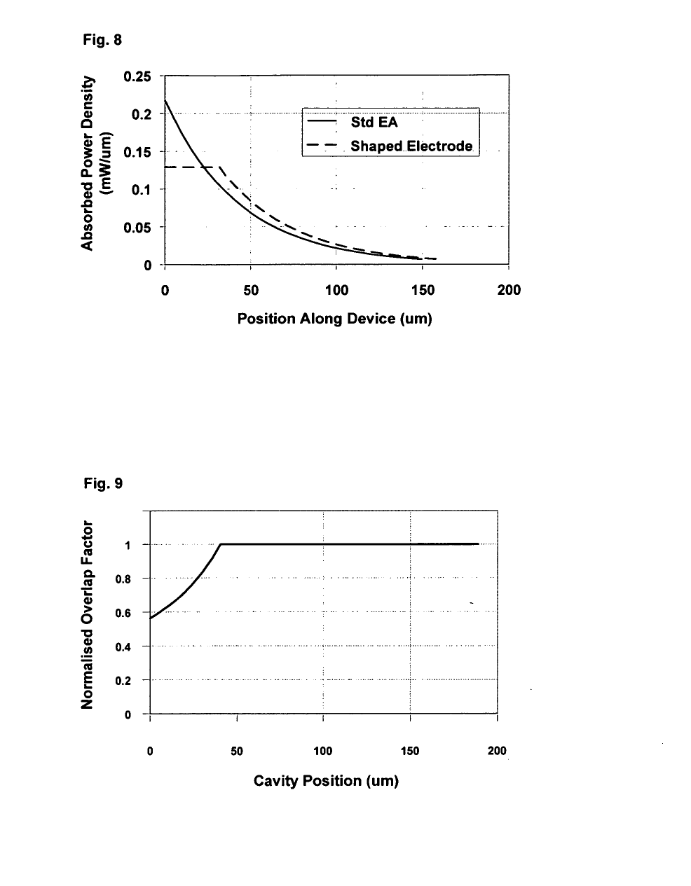

The result of this is a substantial “flattening” of the absorbed optical power decay profile in the front region of the modulator, as shown by the dashed line in the graph of FIG. 8 (and compared in that figure to the “standard” decay profile of a known modulator, shown in FIG. 2). This is represented graphically in a different way in FIG. 9, which shows the normalised value of the overlap factor at each location along the device, i.e. along the waveguide from the front edge of the electrode. The overlap factor is a measure of the optical overlap between the power of the optical mode and the active regions of the device. As shown, the overlap factor is at a relatively low level at the front of the modulator (at the widest parts of the implanted passive regions 9, and the narrowest part of the active region 10), increases on moving in a direction from the front towards the back of the modulator (along the length of the passive regions 9) until it reaches a substantially flat higher level for the remainder of the length of the modulator (behind the passive regions 9) where the active region 10 comprises the entire width of the waveguide 3. Consequently, the undesirable peak in the optical power absorption profile at the input of the known modulator is avoided, thus avoiding the above-described problems with the known devices. In particular, because the optical power absorption at the input is lowered, the heat generation caused by such absorption is reduced, the likelihood of damage to the device is reduced, and the reliability of the device is increased.

Through judicious engineering of the passive region 9, and thus of the overlap factor, it is possible to design a device in which the absorbed power density is constant at the front of the modulator over an interval of length L. The equation below describes the form of the overlap factor in such a front region:

$$\frac{Γ ( z )}{Γ ( L )} = \frac{γ}{1 - ( 1 - γ ) z / L}$$

where Γ(z) is the fraction of the optical power at a distance z from the front of the electrode that overlaps with the absorbing medium (the non-passive part of the active layer), and γ is the ratio of the power in the optical mode at z=L and z=0.

One skilled in the art will appreciate that other factors in the device's design have a bearing on the temperature distribution within the modulator, such as the areal current density and the thermal dissipation of the structure. The overlap factor can alternatively be engineered to optimise the areal current distribution within the modulator. Further, by means of a more comprehensive three dimensional model of the modulator that takes into account the thermal dissipation of the structure it is possible to produce a more accurate optimisation of the temperature distribution.

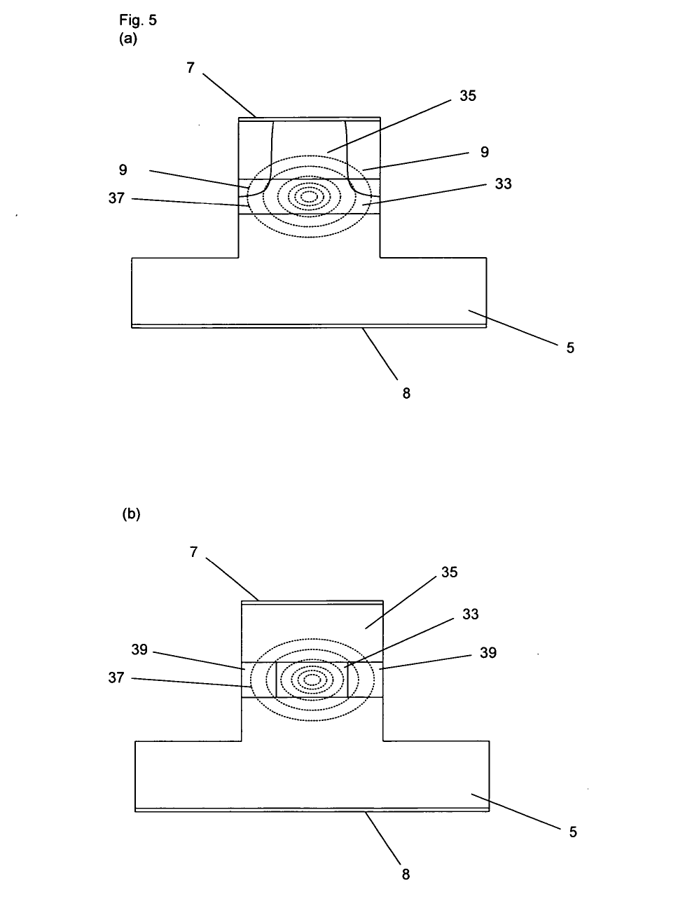

FIG. 5(a) shows a cross section through the waveguide of FIG. 3 at a position where there are passive regions of ion implantation 9. As is conventional the device is built up of a series of layers, with an active layer 33 bounded by an upper conducting layer 35 and a lower conducting layer, which may comprise at least the substrate 5. The active layer may include quantum wells or quantum dots. The structure may include further layers, but they are not material to the invention and are not shown for clarity. The position of the mode is indicated by the dotted pattern 37. The depth of the ion implantation 9 is such that it penetrates at least the upper conducting layer 35. FIG. 5(b) shows a corresponding illustration of the case in which quantum well intermixing or regrowth of insulating material is used to provide electrically insulating regions of active layer 33, instead of implantation, and where regions 39 are the intermixed or regrown regions of the waveguide. An exemplary insulating material 39 is Iron doped Indium Phosphide, although others that may be suitable will be known to one skilled in the art.

The shapes, sizes and locations of the implanted passive regions 9 of the modulator 1 shown in FIG. 3 constitute a particular preferred way of carrying out the invention, but the invention (at least in its broadest aspect) encompasses any variation in the relative proportions of the active and passive regions of the waveguide, along at least part of the length of the waveguide.

FIG. 4 shows an alternative embodiment of the invention, in which an implanted passive region 11 of the waveguide 3 comprises a comb-like pattern of stripes or teeth of insulating or semi-insulating material oriented such that their longest dimension extends lengthwise along the waveguide. In particular, the implanted passive region 11 is substantially continuous across the width of the waveguide at its forwardmost edge region (in the direction of propagation of the light, as indicated by the arrow), but behind this region it extends into tapering stripes or teeth. Consequently, similarly to the FIG. 3 embodiment, the proportion of the waveguide constituting the implanted passive region decreases lengthwise along the waveguide from the front of the implanted region to the rear of the implanted region, and therefore the degree of overlap between the active region and the light propagating through the waveguide increases in a direction from the front to the back of the implanted region. The effect of this arrangement is similar to that exhibited by the FIG. 3 embodiment, i.e. a general “flattening” of the absorbed optical power density in the front region of the modulator.

It will be appreciated that any of a wide variety of possible implantation patterns or shapes having the same, or similar, effect to that of the embodiments shown in FIGS. 3 and 4 may be adopted. For example, at least in the broadest aspect of the invention, substantially any arrangement in which the proportion of the waveguide constituting a region of reduced electrical conductivity decreases along the waveguide in the direction of propagation of the light, may be used. E.g. a combination of the arrangements shown in FIGS. 3 and 4, may be used.

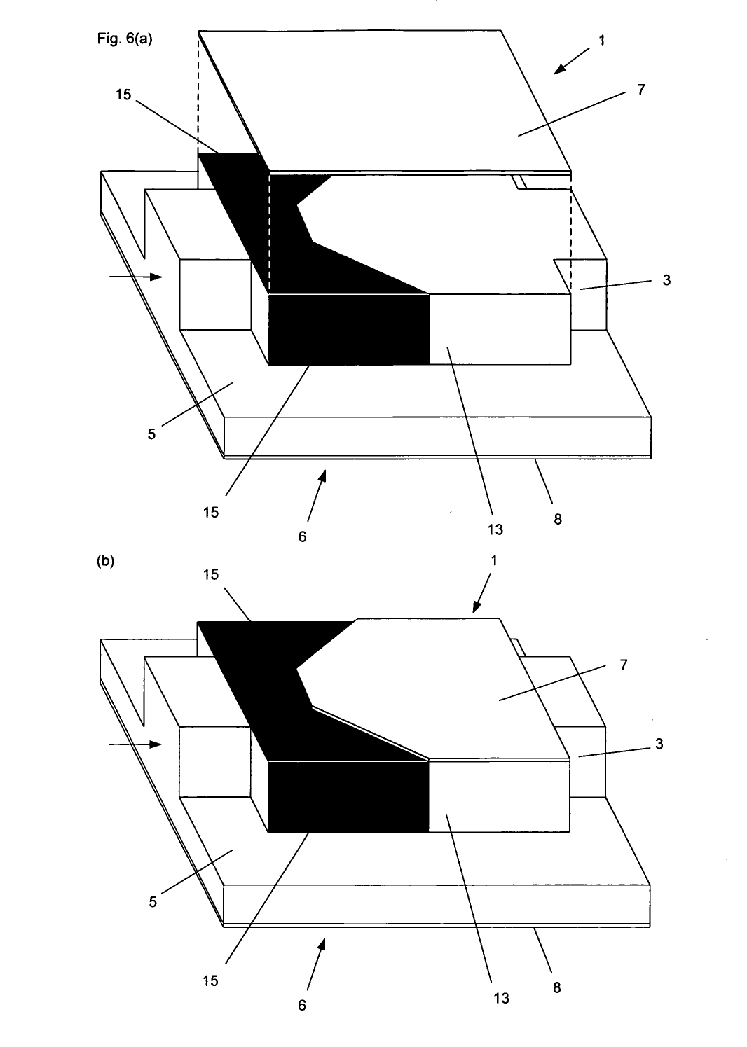

FIG. 6(a) shows a further embodiment of the invention, in which the width of the waveguide is greater in a region 13 than it is elsewhere (or at least wider than it is at each end of the region 13). In particular, the waveguide 3 comprises a single-mode waveguide apart from in the region 13, which comprises a multi-mode interference (MMI) region of the waveguide. Consequently, the modulator 1 shown in FIG. 6(a) includes a 1×1 multi-mode interferometer 13. The effect of this is to “spread-out”, or disperse or expand the light propagating along the waveguide 3, thereby reducing the local optical power density across the area of the device, in the region 13, and improving the management of effects such as excess heat generation and accumulation of carriers. The device shown in FIG. 6(a) also includes an implanted passive region 15 (of reduced electrical conductivity) of the waveguide. In particular, the implanted region 15 of the waveguide constitutes a front region (in the direction of the propagation of the light) of the MMI region 13, and comprises a continuous implantation across the width of the MMI at the front of the MMI, and tapering side regions of implantation extending rearwardly along part of the length of the MMI. Consequently, similarly to the FIGS. 3 and 4 embodiments of the invention, the proportion of the waveguide constituting a region of reduced electrical conductivity decreases in the direction of propagation of the light. Additionally the local optical power density across the area of the device is reduced by a “spreading-out” effect of the MMI region.

The MMI region 13 may, for example, be 2 to 4 times (e.g. approximately 3 times) wider than the width of the waveguide 3 beyond each end of the MMI region. For example, a single-mode waveguide 3 may have a width of approximately 2 μm, and the MMI region 13 may have a width of approximately 6 μm.

FIG. 6(b) shows an example of an embodiment that is similar to that of FIG. 6(a), and which incorporates a further aspect of the invention, an electrode 7 whose shape varies along the length of the waveguide. Furthermore, the electrode 7 does not extend from the front of the MMI region but rather is spaced back from the front edge of the MMI region, and also widens from a relatively narrow front part until it fills the entire width of a surface of the MMI region. The electrode 7 of FIG. 6(b) may advantageously have a lower capacitance than the electrode 7 of FIG. 6(a).

The combined effects of the various features of the FIG. 6(b) embodiment are an overall reduction in the local optical power density across the area of the device (due to the presence of the MMI region) and a flattening of the front peak of the profile (due to the locations and shapes of the implanted region and the electrode).

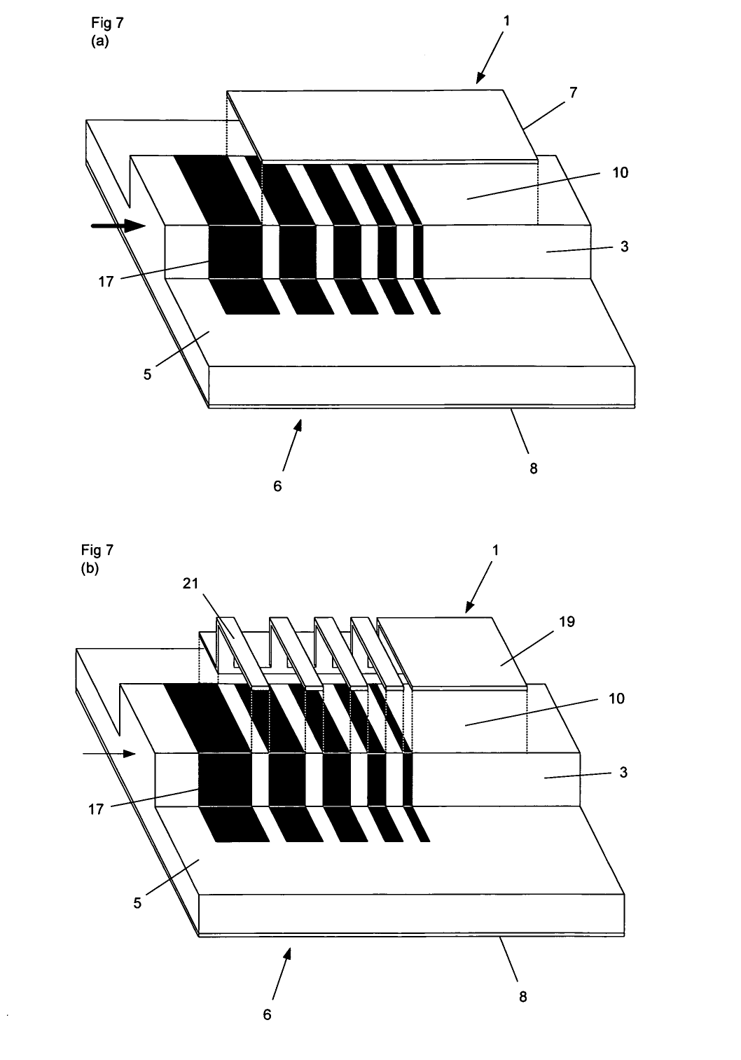

Another embodiment of a modulator 1 according to the invention is illustrated in FIG. 7(a). In this embodiment, the waveguide 3 includes implanted passive regions 17 of low electrical conductivity in the form of stripes extending across the width of the waveguide, separated by active regions 18 also in the form of stripes extending across the width of the waveguide. The width of the passive stripes 17 (i.e. in a direction along the length of the waveguide) reduces from a maximum width in a front region of the modulator, to a minimum width further back along the length of the modulator. Thus, the relative proportions of the waveguide that comprise the active and passive regions vary in a direction along the length of the waveguide. This may be regarded as increasing the local average electrical conductivity (or the “bulk” electrical conductivity) of the waveguide as a function of length. Consequently, this embodiment provides another way of creating a profile of the electrical conductivity of the waveguide that is reduced in a region of the modulator and increases along at least part of the length of the modulator (in the direction of propagation of the light, as indicated by the arrow).

FIG. 7(b) illustrates an embodiment of the invention that is similar to FIG. 7(a), and in which the electrode is patterned with stripes 21 and a bulk portion 19 that substantially correspond with the active regions 10 of waveguide 3 within the length of the device 1. The electrode 19, 21 of FIG. 7(b) may advantageously have a lower capacitance than the electrode 7 of FIG. 7(a).

Instead of, or as well as, the use of one or more regions of implanted reduced electrical conductivity material, the invention may utilise a variation in the wavelength at which light is absorbed under the influence of an electric field, in order to vary the effect of the applied electric field on the light propagating along the waveguide. For this purpose, the invention may utilise quantum wells, especially by means of quantum well intermixing (QWI). Thus, for example, any or all of the above-described embodiments of the invention that include one or more implanted regions may instead (or additionally) include one or more such passive regions in the form of QWI regions. The use of quantum wells affects the bandgap of the material of the waveguide, and thus affects the wavelength at which optical absorption occurs. Thus, for example, the bandgap may be blue-shifted (i.e. increased in energy) by the presence of intermixed quantum wells. The effect of varying the bandgap of the material of the waveguide can be equivalent to the effect of varying the electrical conductivity of the waveguide, because each variation can affect the influence of the applied electric field on the light propagating through the waveguide, consequently influencing the optical power absorption profile of the device.

The preferred embodiments of the invention have been described with reference to optical modulators. However, one skilled in the art will also recognise their suitability for use as optical attenuators.

The preferred embodiments of the invention have been described with reference to figures illustrating weakly guiding rib waveguides. However, one skilled in the art will also recognise their suitability for use with strongly guiding rib waveguides or buried rib waveguides.

What is claimed is:

1. An opto-electronic device comprising a waveguide along which light may propagate and an electrode associated with the waveguide and arranged to apply a variable electric field thereto, the waveguide including one or more active regions in which variations in the electric field applied by the electrode to the waveguide cause variations in absorption of the light, and one or more passive regions in which variations in the electric field applied by the electrode to the waveguide cause substantially no variations in any absorption of the light, wherein relative proportions of the waveguide that comprise the active and passive regions vary along at least part of the length of the waveguide.

2. A device according to claim 1, in which an overlap between the active region(s) and the light propagating along the waveguide varies along at least part of the length of the waveguide.

3. A device according to claim 2, in which the overlap between the active region(s) and the light propagating along the waveguide increases along the waveguide in the direction of the propagation of the light.

4. A device according to claim 1, in which the, or each, passive region of the waveguide is electrically insulating or semi-insulating.

5. A device according to claim 4, in which a bulk electrical conductivity of the waveguide along at least part of the length thereof increases in the direction of the propagation of the light.

6. A device according to claim 1, in which a combined cross-sectional area of the passive region(s) in a direction perpendicular to the direction of the propagation of light along the waveguide decreases in the direction of the propagation of the light, along at least part of the length of the waveguide.

7. A device according to claim 1, arranged such that, in use, the proportion of the power of the light propagating along the waveguide that overlaps with the passive region(s) decreases in the direction of the propagation of the light, along at least part of the length of the waveguide.

8. A device according to claim 1, in which at least one passive region comprises a lateral side region of the waveguide.

9. A device according to claim 1, in which at least one passive region has the form of stripes or teeth of material in the waveguide.

10. A device according to claim 9, in which at least some of the stripes or teeth are oriented such that their longest dimension extends lengthwise along the waveguide.

11. A device according to claim 9, in which at least some of the stripes or teeth are oriented such that their longest dimension extends at least partially across the width of the waveguide.

12. A device according to claim 1, in which at least one passive region comprises an ion implanted region.

13. A device according to claim 1, in which at least one passive region comprises quantum wells, preferably intermixed quantum wells.

14. A device according to claim 1, in which the waveguide includes a widened part of the waveguide adjacent to the electrode.

15. A device according to claim 14, in which the widened part of the waveguide comprises a multi-mode interference region of the waveguide.

16. A device according to claim 14, in which at least part of the waveguide other than the widened part comprises a single-mode waveguide.

17. A device according to claim 14, in which the electrode is adjacent to substantially the entire widened part of the waveguide.

18. A device according to claim 14, in which the electrode is adjacent to only a part of the widened part of the waveguide.

19. A device according to claim 18, in which the electrode is at least partially absent from a front portion, in the direction of propagation of the light, of the widened part of the waveguide.

20. A device according to claim 14, in which at least part of the widened part of the waveguide includes at least one passive region.

21. A device according to claim 20, in which at least part of at least one passive region is situated in a front portion, in the direction of propagation of the light, of the widened part of the waveguide.

22. A device according to claim 1, in which the waveguide is a semiconductor waveguide.

23. A device according to claim 1, in which the waveguide is a rib waveguide comprising an elongate rib extending along, and proud of, a substrate in which the waveguide is formed.

24. A device according to claim 23, in which at least one passive region comprises an ion implanted lateral region in one or both sides of the rib of the waveguide.

25. A device according to claim 1, in which the electrode is situated on a surface of the waveguide.

26. A device according to claim 25, in which the surface of the waveguide is a top surface remote from a substrate in which the waveguide is formed.

27. A device according to claim 1, comprising an optical modulator, in which the electric field is applied by a modulating electric voltage supplied to the electrode.

28. A device according to claim 27, in which the modulating electric voltage is a radio frequency (RF) modulating voltage.

29. A device according to claim 1, comprising an optical attenuator, in which the electric field is applied by a substantially DC electric voltage supplied to the electrode.

30. A device according to claim 1, further comprising a second electrode situated on an opposite side of the waveguide to said electrode.

31. A device according to claim 1, further comprising a doped region situated adjacent to the, or each, electrode, preferably including an n-doped region and a p-doped region, and more preferably further including an unintentionally doped region situated between the doped regions.

32. A device according to claim 31, in which the electric field is applied by reverse-biasing the doped regions.
